(19) United States
(12) Patent Application Publication
(10) Pub. No.: US 2008/0214257 A1
(43) Pub. Date: Sep. 4, 2008

(54) Gaming Machine Capable Of Operating To Indicate The Number Of Bets, And Game Playing Method

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/040,320

(22) Filed: Feb. 29, 2008

(30) Foreign Application Priority Data
Mar. 1, 2007 (JP) JP2007-051856

(51) Int. Cl. A63F 13/00

(52) U.S. Cl. 463/12

(57) ABSTRACT

Blackjack is executed by placing a bet using a bet screen 70 displayed on a liquid crystal display 10. On the bet screen 70 is provided a bet-with-a-bonus button 201 in addition to an ordinary bet button 75. When the amount of bets is indicated using the bet-with-a-bonus button 201, a card game which is separate from Blackjack is executed as a bonus game subsequent to Blackjack, and the player is awarded a bonus payout based on an outcome of the bonus game. The odds when the amount of bets is indicated using the bet-with-a-bonus button 201 is x1.7 which is set to be lower than the odds (x2) indicated using only the ordinary bet button 75.

### CROSS-REFERENCE TO RELATED APPLICATIONS

This application is based upon and claims a priority from the prior Japanese Patent Application No. 2007-051856 filed on Mar. 1, 2007, the entire contents of which are incorporated herein by reference.

### BACKGROUND OF THE INVENTION

1. Field of the Invention

This disclosure relates to a gaming machine capable of operating to indicate the number of bets, and a game playing method.

2. Description of Related Art

Conventionally, with games in which a side bet game is executed together with a main game, an operation of indicating the number of bets for the side bet game has been performed separately from an operation of indicating the original number of bets for the main game. Additionally, with the side bet game, it has been determined whether or not to award a bonus payout to a player thereof according to a game outcome in the main game. Furthermore, the determination to award the bonus payout to the player in the side bet game was based on a condition that a low-probability outcome is realized in the main game, since the bonus payout is relatively high (see, for example, U.S. Pat. No. 6,789,801B2, U.S. Pat. No. 5,711,525 and. U.S. Pat. No. 6,874,786B2).

In the above manner, however, an opportunity for the player to be awarded the bonus payout in the side bet game is rare. Furthermore, in order to participate in the side bet game, it is necessary, as stated above, to take the trouble of indicating the number of bets for the side bet game, quite separately from indicating the original number of bets for the main game. Thus, there has been a trend that the player of the main game, who is discouraged by the above situation, will not willingly attempt to be awarded the bonus payout in the side bet game, and recedes from the side bet game.

### SUMMARY OF THE INVENTION

An object of the disclosure is to provide an unprecedented, novel gaming machine and game playing method by adjusting the main game and the bonus payout lottery through a one-time indication of the number of bets.

To achieve the objects of the disclosure, there is provided a gaming machine, comprising: a display device for displaying cards which are dealt in a main game; an input unit for allowing a player to enter instructions related to a progress of the main game; an operation unit for allowing the player to indicate the number of bets of one of a first type and a second type for a win of the player's side in the main game; a memory for storing the number of credits held by the player; and a processor programmed to execute the main game by executing processes of: when the number of bets of the first type is indicated by an operation on the operation unit, (a) displaying on the screen, upon completion of the player's performing the operation of indicating the number of bets using the operation unit, in condition to be face-up of both cards of two cards which have been dealt as player cards, in condition to be face-up of a first card of two cards which have been dealt as dealer cards, and in condition to be face-down of a second card of two cards which have been dealt as the dealer cards; (b) determining, based on the player's instructions using the input unit, whether or not a card is dealt in addition to the player cards which have been displayed on the display device; (c) displaying cards of the number of being dealt additionally as the player cards, if it is determined to deal a card in addition to the player cards; (d) determining, based on a predefined rule, whether or not a card is dealt in addition to the dealer cards which have been displayed on the display device; (e) displaying cards of the number of being dealt additionally as the dealer cards, if it is determined to deal a card in addition to the dealer cards; (f) determining whether or not the player side wins, based on both a combination of a plurality of the cards which have been displayed on the display device as the player cards and a combination of a plurality of the cards which have been displayed on the display device as the dealer cards; and (g) if the player side wins, adding the number of credits calculated using a predefined odds to the number of credits in the memory and storing the sum, when, otherwise, the number of bets of the second type is indicated by an operation on the operation unit, (h) changing the odds to a lower value than the predefined odds and executing the main game; (i) randomly determining whether or not to award a bonus to the player; and (j) if it is determined to award the bonus to the player, adding the number of credits according to the bonus to the number of credits in the memory and storing the sum.

Furthermore, according to another aspect, there is provided a game playing method comprising, so as to make a main game proceed, the steps of: when a player indicates the number of bets of a first type for a win of the player's side in the main game, (a) dealing, upon completion of the player's indicating the number of bets, two face-up cards as player cards, a face-up card as a first card out of two cards of dealer cards, and a face-down card as a second card out of two cards of the dealer cards; (b) determining, based on the player's instructions, whether or not a card is dealt in addition to the player cards; (c) dealing cards of the number of being dealt additionally as the player cards, if it is determined to deal a card in addition to the player cards; (d) determining, based on a predefined rule, whether or not a card is dealt in addition to the dealer cards; (e) dealing cards of the number of being dealt additionally as the dealer cards, if it is determined to deal a card in addition to the dealer cards; (f) determining whether or not the player side wins, based on both a combination of a plurality of the cards as the player cards and a combination of a plurality of the cards as the dealer cards; and (g) if the player side wins, the number of credits calculated using a predefined odds are awarded to the player, when, otherwise, the player indicates the number of bets of a second type for a win of the player's side in the main game; (h) changing the odds to a lower value than the predefined odds and executing the main game; (i) randomly determining whether or not to award a bonus to the player; and (j) if it is determined to award the bonus to the player, awarding the number of credits according to the bonus to the player.

### BRIEF DESCRIPTION OF THE DRAWINGS

FIG. 1 is an explanatory view showing a bet screen displayed on a liquid crystal display of a terminal according to a present embodiment;

FIG. 2 is an outline view of a card gaming machine according to the present embodiment;

FIG. 3 is an outline view of the terminal according to the present embodiment;

FIG. 4 is a block diagram schematically showing a control system of the card gaming machine according to the present embodiment;

FIG. 5 is a block diagram schematically showing a control system of the terminal according to the present embodiment;

FIG. 6 is an explanatory view showing the bet screen displayed on the liquid crystal display of the terminal according to the present embodiment;

FIG. 7 is an explanatory view showing the bet screen displayed on the liquid crystal display of the terminal according to the present embodiment;

FIG. 8 is an explanatory view showing the bet screen displayed on the liquid crystal display of the terminal according to the present embodiment;

FIG. 9 is an explanatory view showing a main screen displayed on a front display according to the present embodiment;

FIG. 10 is a flow chart of a game processing program in the card gaming machine according to the present embodiment;

FIG. 11 is a flow chart of a game processing program in the card gaming machine according to the present embodiment;

FIG. 12 is a flow chart of a game processing program in the card gaming machine according to the present embodiment;

FIG. 13 is a flow chart of a game processing program in the card gaming machine according to the present embodiment;

FIG. 14 is a table showing the difference between an ordinary bet operation and a bet-with-a-bonus operation;

FIG. 15 is an explanatory view showing the bet screen displayed on the liquid crystal display of the terminal according to the present embodiment;

FIG. 16 is a schematic view of an exemplary application of the present invention to a table game.

### DETAILED DESCRIPTION OF THE PREFERRED EMBODIMENTS

In the following, a multi-player card gaming machine according to the present invention will be described in detail referring to the drawings based on an embodiment implemented on a card gaming machine. Here, the card gaming machine according to the present embodiment is one type of multi-player gaming machines comprising a plurality of terminals for accepting inputs from the players and executes Blackjack, which is a kind of card games. Here, Blackjack is a game in which each player first bets a certain amount of chips, then if the total of a number indicated by cards (referred to as “player cards”) dealt to the player is near to “21” than the total of a number indicated by cards (referred to as “dealer cards”) dealt to a dealer, it is determined that the player has won the game, and a payout is made according to the amount of bets.

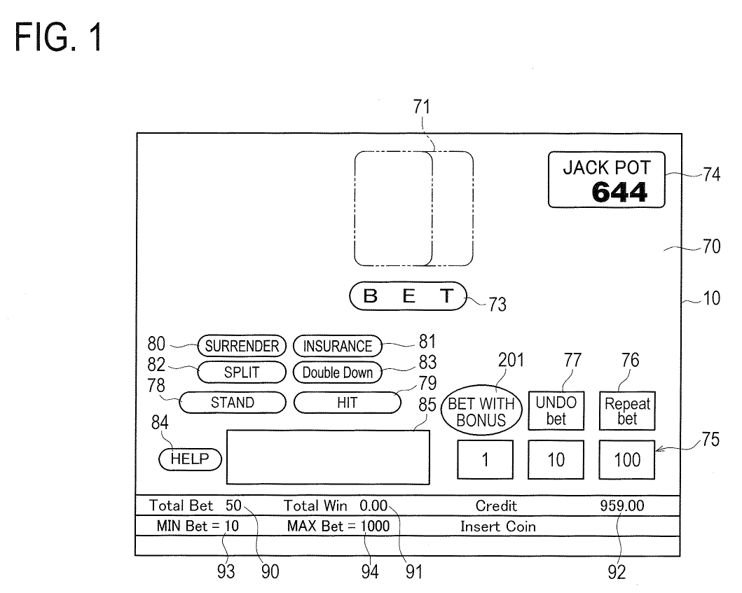

The card gaming machine according to the present invention has, in addition to an ordinary bet button 75, a bet-with-a-bonus button 201, such as a bet screen particularly shown in FIG. 1. When the amount of bets is indicated by both the bet-with-a-bonus button 201 and the bet button 75, a card game which is separate from Blackjack is executed as a bonus game subsequent to Blackjack, and a bonus payout is awarded to the player based on an outcome of the bonus game.

Here, odds is x1.7 when the amount of bets is indicated by both the bet-with-a-bonus button 201 and the bet button 75, which is set to be lower than odds (x2) when the amount of bets is indicated only by the bet button 75.

In the following, for simplicity of description, the phrase “when the amount of bets is indicated by both the bet-with-a-bonus button 201 and the bet button 75” may be occasionally expressed, for example, “when the amount of bets is indicated using the bet-with-a-bonus button 201”.

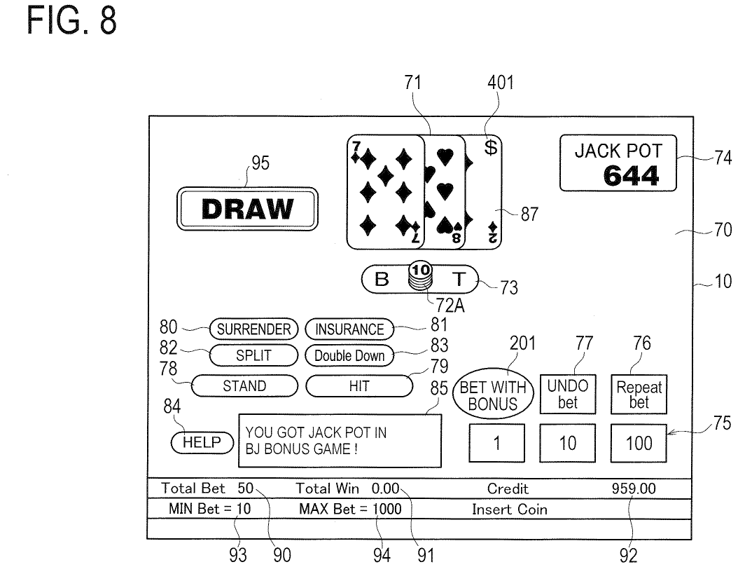

Here, with the card gaming machine according to the present embodiment, when the player and the dealer ended in a draw (it is called a “push”), the amount of the bets the player placed is pooled in a pot (as a profit of a jackpot), such as a bet screen particularly shown in FIG. 8. Then if a predefined condition (for example, the player wins the bonus game executing when the amount of bets is indicated by both the bet-with-a-bonus button 201 and the bet button 75) is realized, the total amount of pool which is pooled in the pot currently is awarded to the player as a prize.

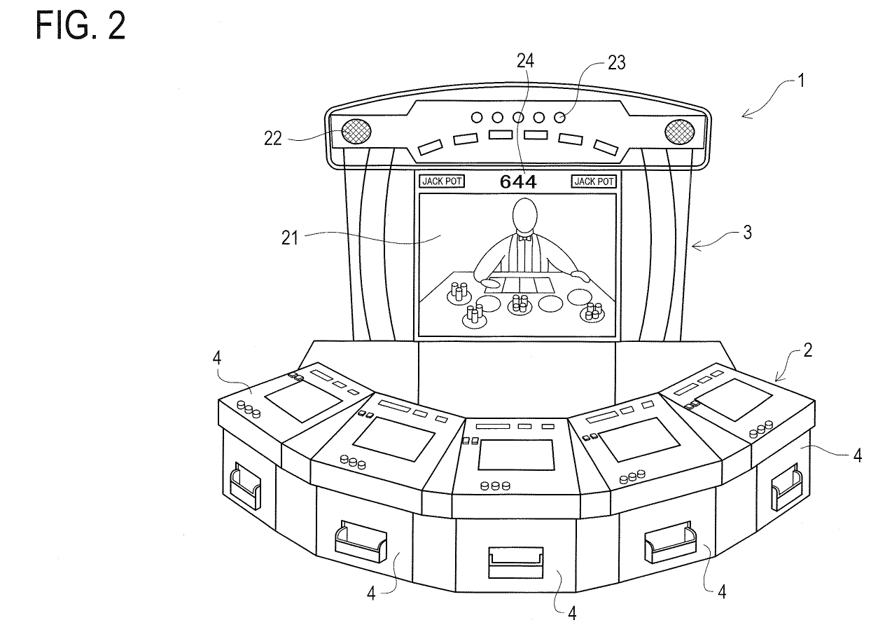

First, a structural overview of the card gaming machine 1 according to the present embodiment will be described, referring to FIG. 2. FIG. 2 is an outline view of the card gaming machine 1 according to the present embodiment.

The card gaming machine 1 according to the present embodiment generally comprises a table unit 2 at which the player sits and plays the game, and a panel unit 3 provided behind the table unit 2 to display animation images of the dealer.

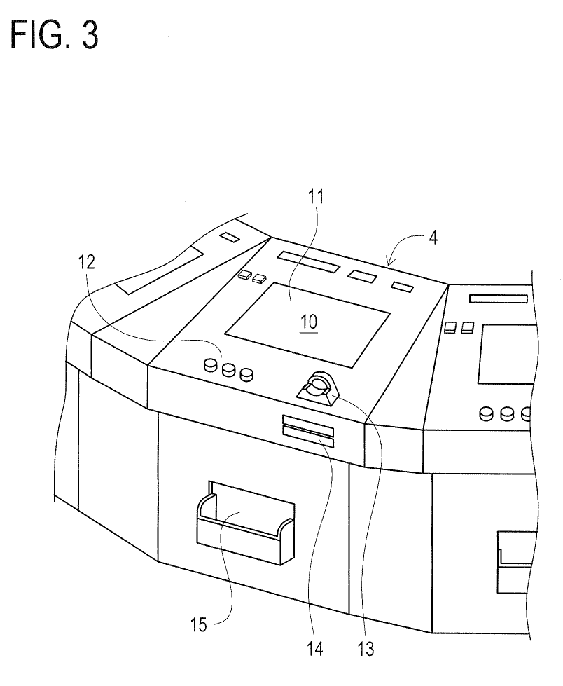

First, the table unit 2 will be described below. The table unit 2 has a plurality (five in FIG. 2) of terminals 4 referred to as satellites arranged in generally a fan-like manner. Here, FIG. 3 is an outline view of a terminal 4 according to the present embodiment.

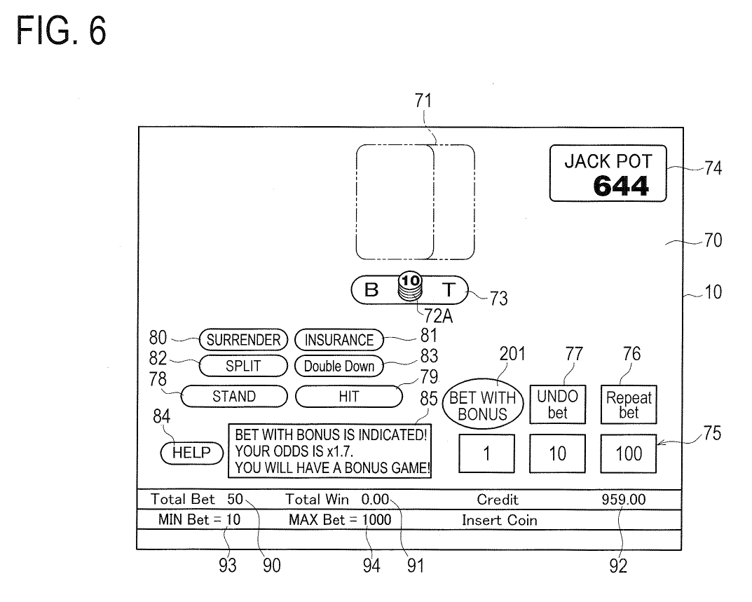

As shown in FIG. 3, the terminal 4 comprises a liquid crystal display 10 for displaying the bet screen (see FIGS. 1 and 6) described below and the game outcome or the like, a touch panel 11 provided on the front face of the liquid crystal display 10 and used for selecting the buttons which are displayed on the liquid crystal display 10 when selecting the bet target and indicating the amount of bets, an operation button 12 for performing a payout operation, a coin insertion slot 13 for inserting coins or medals, a bill insertion slot 14 for inserting bills, and a coin payout opening 15 for paying out, to the player, coins or medals corresponding to the accumulated credits when a payout operation is performed.

In addition, the touch panel 11 is also used for rearranging or selecting the cards displayed on the liquid crystal display 10.

Referring to FIG. 2 again, the panel unit 3 comprises a front display 21 for displaying images of a dealer who is dealing the cards or delivering the chips, and contents of the cards being dealt or the like, speakers 22 provided on the upper part of the front display 21 for outputting music or sound effects along the progress of the game, and LEDs 23 which light up when a variety of effects are performed.

Furthermore, an amount of JP display area 24 are provided on the upper part of the front display 21. Here, with the card gaming machine 1 according to the present embodiment, as stated below, when the player and the dealer ended in a draw, the amount of the bets the player placed is pooled in the pot. If the player wins the bonus game executing when the amount of bets is indicated by both the bet-with-a-bonus button 201 and the bet button 75, the total amount of pool is awarded to the player. The JP display area 24 displays the total amount of pool which is pooled currently.

Here, the cards used in the card gaming machine 1 according to the present embodiment are same as commonly used playing cards, bearing “marks” which are composed of “suits” and “numbers” (see FIG. 8).

A “suit” indicates the symbol on the playing cards. There are four types of suits: spade, heart, diamond and club.

A “number” indicates the numeral or alphabet on the playing cards. There are 13 types of them: A (Ace, equivalent to 1), 2, 3, 4, 5, 6, 7, 8, 9, 10, J (Jack, equivalent to 11), Q (Queen, equivalent to 12), and K (King, equivalent to 13).

A “mark” indicates the type of card determined by a combination of a “suit” and a “number” of the playing card such as, for example, “A of heart”, “K of spade” or the like. Then, a card deck refers to a set of 53 cards necessary for a card game, consisting of 52 cards, which is a combination of the 13 numbers and each of the four types of suits, plus a joker.

Next, a playing method of Blackjack in the card gaming machine 1 arranged as above will be described, wherein the player who is going to play the game sits in front of the terminal 4 and places a desired amount of bets using the bet screen displayed on the liquid crystal display 10. Subsequently, images of the player cards and the dealer cards which have been dealt for the player and the dealer, respectively, are displayed on the front display 21 and each of the liquid crystal displays 10. Then, image effects announcing that either the player or the dealer is the winner or image effects announcing that the result is a draw are displayed, based on the types of the marks of the cards which have been dealt as the cards. Furthermore, credits twice the amount of bets (number of credits) which has been placed is provided as an award at each of the terminals 4 if the player beats the dealer. However, as stated above, if the amount of bets is indicated by both the bet-with-a-bonus button 201 and the bet button 75, credits 1.7 times the amount of bets (number of credits) which has been placed is provided as an award. On the other hand, no award is provided if the player loses to the dealer. Furthermore, if he or she ended in a draw with the dealer, no award is provided and the amount of the bets (the numbers of the credits) is pooled in the pot. Additionally, when the amount of bets is indicated by both the bet-with-a-bonus button 201 and the bet button 75 in particular, a card game separate from Blackjack is executed as the bonus game subsequent to Blackjack, regardless of the player's winning, losing, or ending in a draw in Blackjack, and a bonus payout is awarded to the player based on the outcome of the bonus game. The bonus payout is the total amount of pool which is pooled in the pot currently.

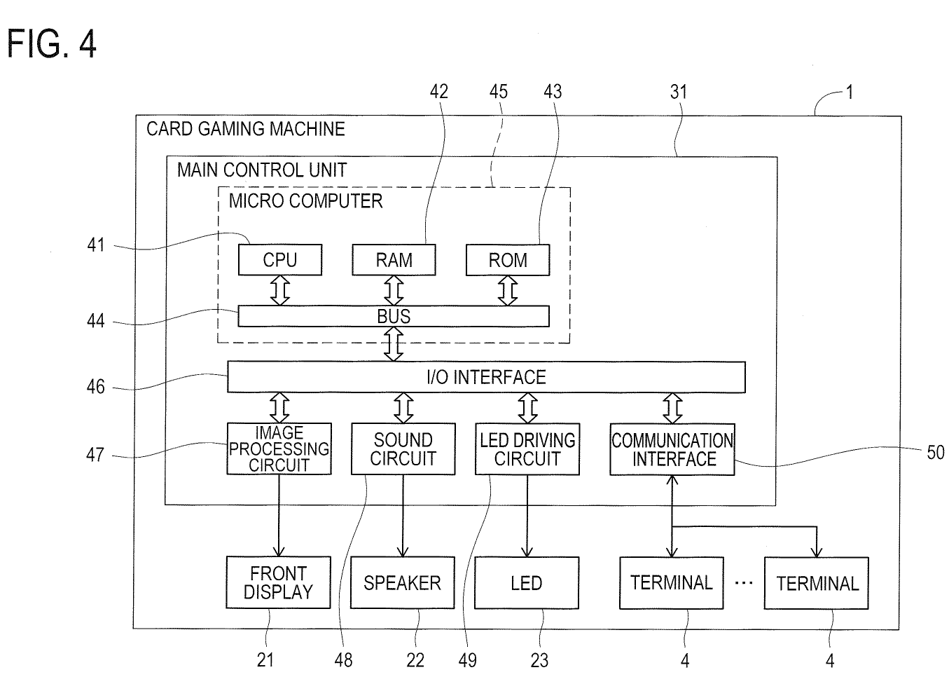

Next, the arrangement related to a control system of the card gaming machine 1 will be described, referring to FIG. 4. FIG. 4 is a block diagram schematically showing the control system of the card gaming machine 1 according to the present embodiment.

The card gaming machine 1 according to the present embodiment comprises, as shown in FIG. 4, a main control unit 31, a plurality of terminals 4 connected to the main control unit 31, and a variety of peripheral devices.

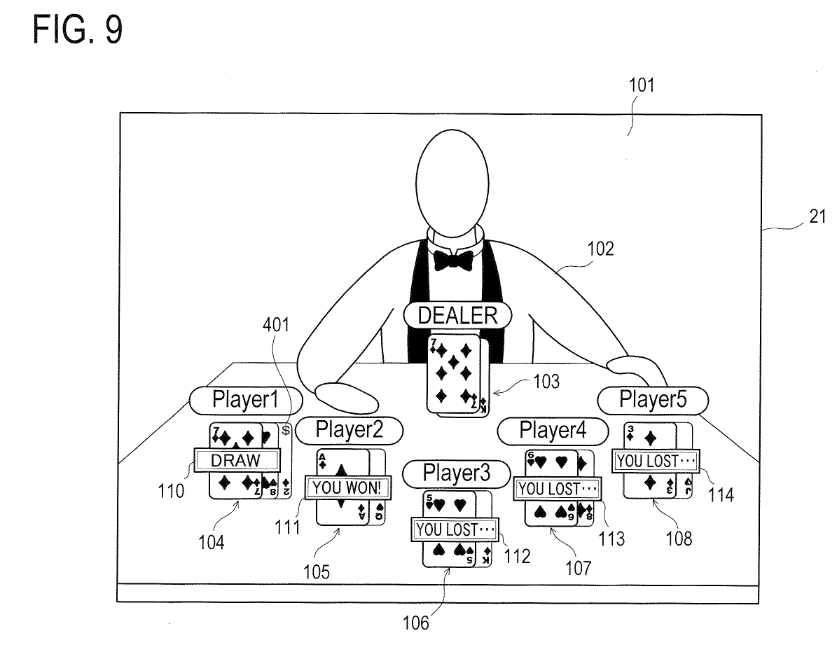

The main control unit 31 is generally composed of a micro-computer 45 as the kernel comprising a CPU 41, a RAM 42, a ROM 43 and a bus 44 for transferring data mutually between these elements. The ROM 43 stores a variety of programs, data tables or the like for executing necessary processes to control the card gaming machine 1. The RAM 42 is a memory for temporarily storing a variety of data which have been operated in the CPU 41. Furthermore, the ROM 43 also stores face-up and face-down image data of the cards used as the player cards or dealer cards. Particularly, with the card gaming machine 1 according to the present embodiment, a card game which is separate from Blackjack may be executed as the bonus game subsequent to Blackjack as stated above, in which case image data of a mark of “$” used in the bonus game is also stored (see FIGS. 8 and 9). The RAM 42 provides an amount of pool storing area 42A for saving the amount of pool which is pooled in the pot.

In addition, the CPU 41 is connected, via an I/O interface 46, to an image processing circuit 47, a sound circuit 48, an LED driving circuit 49, and a communication interface 50.

The main control unit 31 receives player's bet operation information related to the amount of bets from each of the terminals 4 and determines whether or not a condition is realized to start the game of Blackjack. Then, upon starting the game of Blackjack, the main control unit 31 assigns, based on a lottery result, a predefined pieces of cards (minimum, two cards) out of the 53 playing cards to the player and the dealer, respectively (on the display screen, the cards are dealt to the player and the dealer, respectively). As the result, the win or loss (either the player or the dealer has won, or they ended in a draw) is determined based on the hand of the assigned cards, and the main control unit 31 transmits the result of determination to each of the terminals 4. Subsequently, each of the terminals 4 increases or decreases the accumulated credits according to the result of win or loss received from the main control unit 31.

Furthermore, the main control unit 31 identifies the terminal 4 at which the player's bet operation has been performed on both the bet-with-a-bonus button 201 and the bet button 75 according to the bet operation information received from each of the terminals 4, for the identified terminal 4, regardless of the win or loss result of Blackjack, and determines whether or not a card which is marked with a mark of “$” is one of the player cards which are dealt to the player. Then the main control unit 31 transmits the determination result to the terminal 4. Subsequently, based on the result of win or loss for the bonus which is received from the main control unit 31, the terminal 4 increases the accumulated credits by amount of the bonus payout, only when a card which is marked with a mark of “$” is one of the cards which are dealt as the player cards.

In addition, the main control unit 31 also outputs image signals to be displayed on the front display 21, and controls driving of the speakers 22 and the LEDs 23.

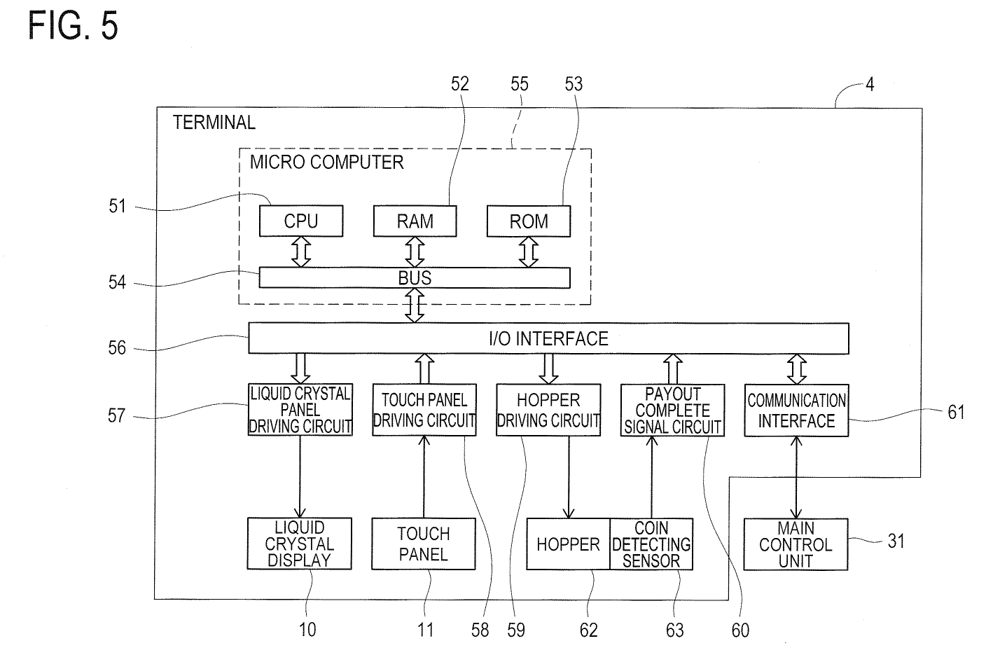

Next, the arrangement related to a control system of the terminal 4 will be described, referring to FIG. 5. FIG. 5 is a block diagram schematically showing the control system of the terminal 4 according to the present embodiment.

The terminal 4 according to the present embodiment is generally composed of a microcomputer 55 as the kernel comprising a CPU 51, a RAM 52, a ROM 53 and a bus 54 for transferring data mutually between these elements, as shown in FIG. 5. ROM 43 includes a variety of programs, data tables or the like stored therein for executing necessary processes to control the terminal 4. The RAM 52 is a memory for temporarily storing a variety of data which have been operated in the CPU 51, such as the number of credits (that is, the number of credits held by the player at the terminal 4) currently accumulated on the terminal 4, the bet target on which the player placed a bet, the bet type (whether or not the bet-with-a-bonus button 201 has been used), the amount of bets (number of credits) which has been placed on the bet target or the like.

In addition, the CPU 51 is connected, via an I/O interface 56, to a liquid crystal panel driving circuit 57, a touch panel driving circuit 58, a hopper driving circuit 59, a payout complete signal circuit 60, and a communication interface 61. Furthermore, a liquid crystal display 10 is connected to the liquid crystal panel driving circuit 57, a touch panel 11 is connected to the touch panel driving circuit 58, a hopper 62 is connected to the hopper driving circuit 59, and a coin detecting sensor 63 is connected to the payout complete signal circuit 60, respectively. Additionally, the main control unit 31 is connected to the communication interface 61.

Based on operation information which is output from the touch panel 11, the CPU 51 calculates the amount of bets (number of credits) placed by the player, then, together with information about whether or not the bet operation has been performed using the bet-with-a-bonus button 201 (type of bet), stores them into the RAM 52 and transmits them to the main control unit 31. Furthermore, the CPU 51 increases or decreases the accumulated credits according to the win or loss transmitted from the main control unit 31. Additionally, when the player has performed the bet operation using the bet-with-a-bonus button 201, the CPU 51 increases the accumulated credits according to the win or loss for the bonus transmitted from the main control unit 31.

In addition, the CPU 51 also outputs image signals to be displayed on the liquid crystal display 10, and controls payout of coins from the coin payout opening 15 by the hopper 62 and the coin detecting sensor 63.

Next, a bet screen 70 which is displayed on the liquid crystal display 10 of the terminal 4 when Blackjack is played on the card gaming machine 1 according to the present embodiment will be described, referring to FIG. 1 and FIGS. 7 and 8. FIG. 1 and FIGS. 6 and 8 are diagrams showing the bet screen 70 displayed on the liquid crystal display 10 of the terminal 4. Here, with the card gaming machine 1 according to the present embodiment, the player uses the bet screen 70 and the touch panel 11 to perform a bet operation of placing a certain amount of credits. With regard to this, the bet operation includes an ordinary bet operation which is performed only on the bet button 75 without using the bet-with-a-bonus button 201, and a bet-with-a-bonus operation which is performed on both the bet-with-a-bonus button 201 and the bet button 75. In addition, an operation to demand dealing one more card, and an operation to increase the amount of the bets, can also be performed by the player using the bet screen 70 and the touch panel 11.

As shown in FIG. 1, and FIGS. 6 and 8, the bet screen 70 comprises a player card display area 71 for displaying the images 87 (see FIG. 8) of the cards dealt to the player, a chip display area 73 for displaying a image 72 (see FIGS. 6 to. 8) of the chips which have been bet, an amount of pool display area 74 for displaying the amount of credits pooled in the pot, and information display area for displaying a variety of operation buttons and information of the player.

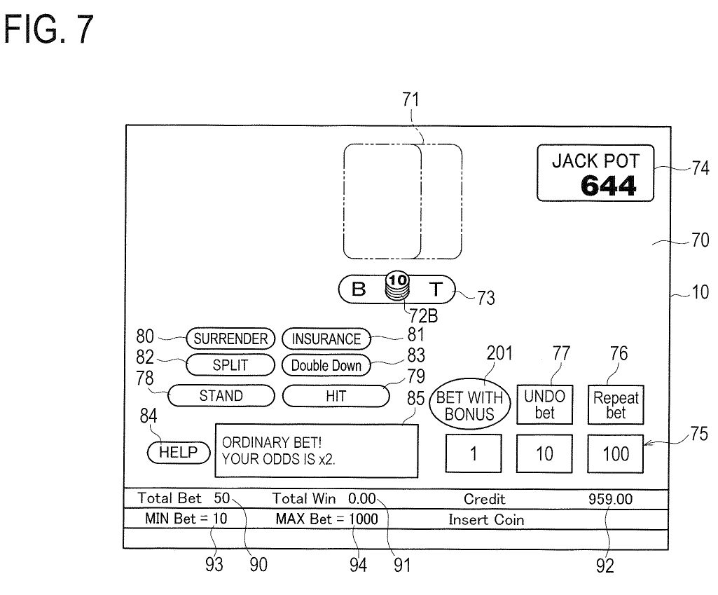

Here, the image 72 of chips (see FIGS. 6 to 8) includes an image 72A of chips (see FIGS. 6 and 8) which is displayed for a bet-with-a-bonus operation performed on both the bet-with-a-bonus button 201 and the bet button 75, and an image 72B of chips (see FIG. 7) which is displayed for an ordinary bet operation performed only on the bet button 75 without using the bet-with-a-bonus button 201. With regard to this, both images 72A and 72B of chips are distinctly displayed using different colors or the like, although not shown.

Here, the player card display area 71 is a display area for displaying the images 87 (see FIG. 8) of the cards which are dealt to the player. Then, the images 88 of a plurality of cards (the player cards) displayed on the player card display area 71 become the cards to be dealt to the player who is sitting at the terminal 4 to play the game.

The chip display area 73 displays the image 72 of chips corresponding to the amount of bets placed by the player (for example, chips corresponding to 50 credits are bet in FIGS. 6 to 8). The player then selects the amount of bets using the bet button 75, determines the amount of bets by touching the chip display area 73. The terminal 4 transmits the determined amount of bets to the main control unit 31.

The amount of pool display area 74 is a display area for displaying the amount of pool which is pooled in the pot. Here, with the card gaming machine 1 according to the present embodiment, when the player and the dealer ended in a draw, the total amount of the bets the player placed is pooled in the pot. With regard to this, the part amount of the bets the player placed may be pooled in the pot. In this case, it is desirable that the remaining amount of the bets the player placed is paid to the player.

In addition, a plurality of the bet buttons 75 (three in the present embodiment, i.e., “one credit”, “10 credits”, and “100 credits”) are provided on the lower right hand side of the chip display area 73. Then, the player can select the amount of bets to be placed in the current game by touching the bet button 75.

Additionally, the bet-with-a-bonus button 201 is provided above the bet button 75. The player can indicate the amount of bets using the bet button 75 as a bet-with-a-bonus operation by touching the bet-with-a-bonus button 201 once.

However, if the amount of bets is indicated by using only the bet button 75 without touching the bet-with-a-bonus button 201, the operation turns out to be an ordinary bet operation.

Furthermore, a Repeat bet button 76 and an UNDO bet button 77 are provided above the bet button 75. The player can place a bet which is the same amount of bets as the previous game by touching the Repeat bet button 76. In addition, a bet operation performed once can be canceled by touching the UNDO bet button 77. Furthermore, a bet-with-a-bonus operation can be canceled by touching the UNDO bet button 77.

On the other hand, a group of operation buttons are provided on the lower left hand side of the chip display area 73. The group of operation buttons is used in taking a tactics of Blackjack between the player and the dealer. Specifically, a STAND button 78, a HIT button 79, a SURRENDER button 80, an INSURANCE button 81, a SPLIT button 82, and a Double Down button 83 are provided, as the operation buttons.

The STAND button 78 is the button which is touched when the player plays the player cards with the dealer without demanding the deal of the player cards now. The HIT button 79 is the button which is touched when the player demands a card in addition to the dealt player cards newly now. In addition, the player can touch the HIT button 79 till the total of a number indicated by the player cards is as above “21”.

The SURRENDER button 80 is the button which is touched when the player gives up the game of Blackjack. When the SURRENDER button 80 is touched, while the half of the amount of bets at the point in time is collected, the remaining half is repaid by the player. The INSURANCE 81 button 81 is the button which is touched when the player takes an insurance against being to Blackjack which consisted of a combination of the dealer cards which are dealt to the dealer.

The SPLIT button 82 is the button which is touched when the player divides the player cards into two hands (player cards) on condition that a number indicated by two pieces of cards dealt in a game is the same number. And the players can play with the dealer by the hands (player cards) of more than two sets of cards. The Double Down button 83 is the button which is touched when the player increases the amount of bets to double in a game.

In addition, a HELP button 84 is provided below the STAND button 84. The HELP button 84 is a button to be touched when displaying operation instructions of the card gaming machine 1 on the liquid crystal display 10. Additionally, a message area 85 for displaying messages that support the progress of the game is provided on the right hand side of the HELP button 84.

On the message area 85, messages such as “BET WITH BONUS IS INDICATED! YOUR ODDS IS x1.7. YOU WILL HAVE A BONUS GAME!” are displayed, as shown in FIG. 6 while a bet-with-a-bonus operation is being performed. While, on the other hand, an ordinary bet operation is being performed, messages such as “ORDINARY BET. YOUR ODDS IS x2.” are displayed, as shown in FIG. 7.

At the lower part of the bet screen 70, a bet amount display area 90 for displaying the amount of bets currently placed by the player, an acquisition amount display area 91 for displaying the amount provided to the player as an award in the game, a held credit display area 92 for displaying the number of credits currently held by the player, a lower-limit-of-bet-amount display area 93 displaying the lower limit of the amount of bets that can be placed by the player, and an upper-limit-of-bet-amount display area 94 displaying the upper limit of the amount of bets that can be placed by the player, are provided.

Additionally, as shown in FIG. 8, a win-or-loss display area 95 displaying the win or loss of the player and the dealer in the current game is provided on the left hand side of the player card display area 71. Here, the side where the total of a number indicated by the hand cards is near to “21”, in the range where the total do not exceed “21”, is determined with the winner of Blackjack. On the other hand, a draw of Blackjack is determined when the total of a number indicated by the player cards is equal to the total of a number indicated by the dealer cards. In this manner, a character string “DRAW” is displayed on the win-or-loss display area 95 when the outcome is a draw. If the player wins, a character string “YOU WON” is displayed on the win-or-loss display area 95. Furthermore, a character string “YOU LOST” is displayed on the win-or-loss display area 95 when the player is defeated.

Next, a main screen 101 displayed on the front display 21 will be described referring to FIG. 9, when playing Blackjack in the card gaming machine 1 according to the present embodiment.

FIG. 9 is a diagram showing the main screen 101 displayed on the front display 21. Here, with the card gaming machine 1 according to the present embodiment, an image 102 of the dealer animated to perform dealing of the cards along the progress of the game is displayed on the main screen 101 in order to improve the sense of reality of the game.

An image 103 of the dealer cards, which are the dealer's hand cards dealt to the dealer, is displayed generally in the middle of the main screen 101. Furthermore, on the lower part of the main screen 101, images 104 to 108 of cards (the player cards) which are dealt to each of the players (maximum, five persons) who plays the game at the terminals, is displayed. And, on the lower part of the main screen 101, a plurality of win or loss result images 110 to 114 which announced win or loss result of each of the players and the dealer respectively, is displayed. The player can recognize, referring to the main screen 101, the type of the cards dealt to the dealer or to the other player. And the player can recognize, referring to the main screen 101, win or loss result of the game of the player or the other player.

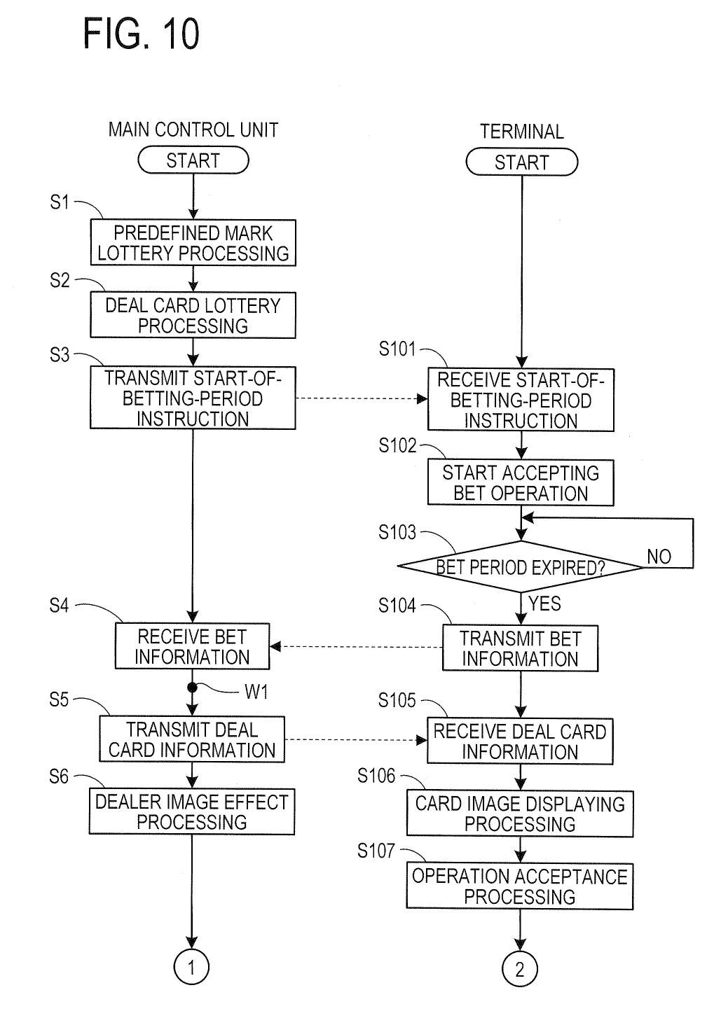

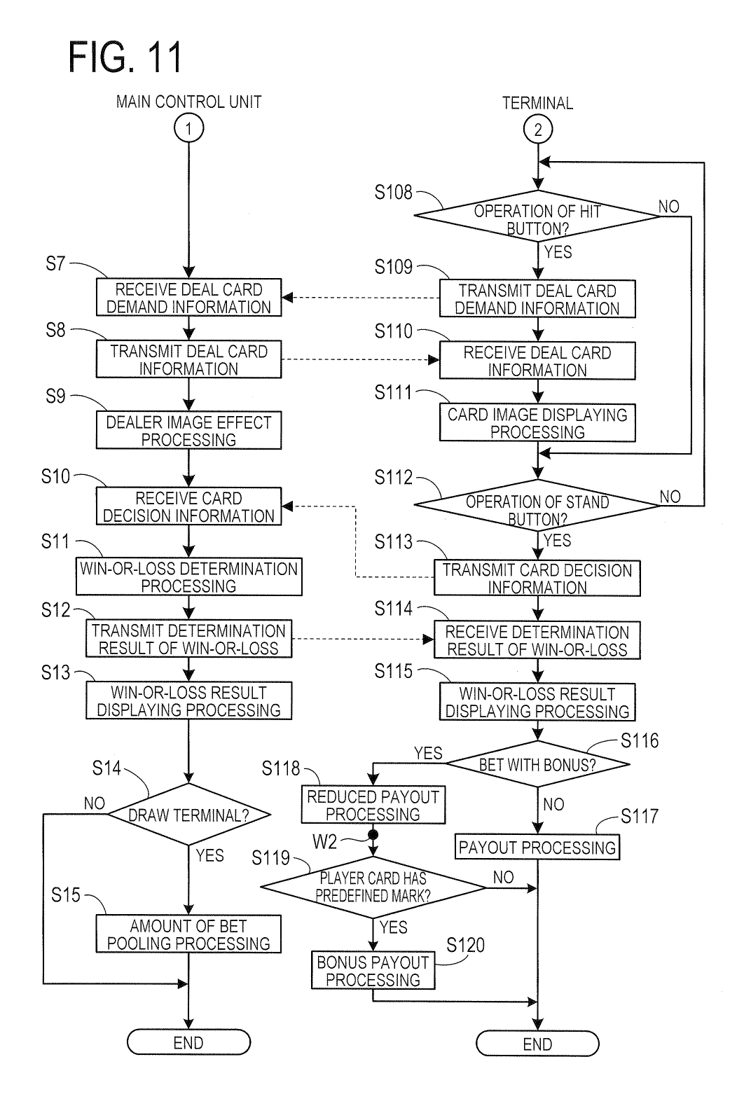

Next, a game processing program executed by the CPU 41 of the main control unit 31 and a game processing program at the terminal side executed by the CPU 51 of the terminal 4, respectively in the card gaming machine 1 according to the present embodiment, will be described, referring to FIGS. 10 and 11. Here, respective programs shown as a flow chart in FIGS. 10 and 11 are stored in the RAM 42 or the ROM 43 provided in the main control unit 31, or the RAM 52 or the ROM 53 provided in the terminal 4, and are executed by the CPU 41 or the CPU 51.

First, the game processing program executed by the main control unit 31 will be described, referring to FIGS. 10 and 11. In step (abbreviated to S hereafter) 1, the CPU 41 executes a predefined mark lottery processing. Specifically, assuming that there are N cards (N=53 in Blackjack) to be used in the game, a number (deal order) within the range of 1 to N is associated with each one of the cards. Then, a plurality (for example, five) of number within the range of 1 to N are drawn. The each card associated with the drawn numbers is marked with a mark 401 of “$” (see FIGS. 8 and 9). Furthermore, in S2, the CPU 41 executes a deal card lottery processing to draw cards which are associated with the player and the dealer. Specifically, according to the number (deal order) associated of S1, the cards are associated to the player and the dealer respectively. In other words, the player cards are dealt to the player and the dealer cards are dealt to the dealer.

Subsequently, in S3, the CPU 41 transmits, to each of the terminals 4, an instruction to start a betting period for accepting the player's bet operation.

Next, in S4, the CPU 41 receives bet information transmitted from each of the terminals 4. Here, the bet information includes information relating to the amount of bets (number of credits) placed by the player, and information relating to the type of bet (whether or not the bet operation has been performed using the bet-with-a-bonus button 201) placed by the player. In addition, the received bet information of each terminal 4 is temporarily stored in the RAM 42.

Subsequently, in S5, the CPU 41 transmits, to each of the terminals 4, deal card information relating to the first and the second card associated (dealt) to the player at each of the terminals 4 (for example, information about the marks such as “7 of heart”, “A of spade”, or having a mark of “$” or not), based on the lottery result of the deal card lottery processing of S2. Then, in S6, the image 102 of the dealer who deals two cards respectively to the player and the dealer is displayed on the front display 21 as the main screen 101 (see FIG. 9). Here, the type of the mark, which is marked on the second card dealt to the dealer as the dealer cards, is not displayed at the point in time that the second card is dealt to the dealer. In other words, the second card dealt to the dealer is face-down.

Next, in S7, the CPU 41 receives a demand to deal a new card transmitted from each of the terminals 4. Then, according to the demand, the CPU 41 transmits deal card information relating to the third card or the subsequent cards, to the terminal 4 which transmitted the demand (S8). Furthermore, in S9, the image 102 of the dealer who deals a new cards to the player demanded is displayed on the front display 21 as the main screen 101 by the CPU 41.

Then, in S10, the CPU 41 receives card decision information transmitted from each of the terminals 4. The card decision information is information which is transmitted when the player determines to play with the dealer by using the card dealt currently. The card decision information is transmitted to the main control unit 31 when the player touched the STAND button 78, as stated below.

Then, in S11, the CPU 41 compares the hand cards (the player cards) associated (dealt) to the player with the hand cards (the dealer cards) associated (dealt) to the dealer and determines the win or loss. Specifically, the side where the total of a number indicated by the hand cards is near to “21”, in the range where the total do not exceed “21”, is determined with the winner of the game. On the other hand, a draw of the game is determined when the total of a number indicated by the player cards is equal to the total of a number indicated by the dealer cards.

Subsequently, in S12, the determination result of win or loss of S11 is transmitted to each of the terminals 4 by the CPU 41. Additionally, in S13, the CPU 41 displays, on the main screen 101 of the front display 21, a result of win or loss image 110 to 114 announcing the determination result of win or loss of each of the terminals 4 (see FIG. 9).

Furthermore, in S14, the CPU 41 determines whether or not there is the terminal 4 which is determined a draw of the game in the determination result of win or loss of S11. If there is the terminal 4 which is determined a draw of the game (S14:YES), the CPU 41 reads the amount of bets which is bet at the terminal 4 which is determined a draw of the game from the RAM 42. And the CPU 41 adds the amount of bets to the numbers of pool in the amount of pool storing area 42A of the RAM 42 and stores the sum in the amount of pool storing area 42A of the RAM 42. With regard to this, the numbers of pool in the amount of pool storing area 42A is awarded to the player who sits at the terminal 4, which is determined that a card marked with a mark 401 of “$” is one of the hand cards (the player cards) which are dealt to the player in a following game. On the other hand, if there is no terminal 4 which is determined a draw of the game (S14: NO), the game processing program terminates.

Next, the game processing program executed by the terminal 4 will be described, referring to FIGS. 10 and 11. In S101, the CPU 51 receives the instruction to start the betting period from the main control unit 31.

Subsequently, in S102, the CPU 51 displays the bet screen 70 (see FIGS. 1, 6 to 8) on the liquid crystal display 10, and identifies the amount of bets (the number of credits) which has been placed, based on operation information from the touch panel 11. In addition, the CPU 51 identifies the type of bet placed by the player (whether or not a bet operation has been performed using the bet-with-a-bonus button 201). Furthermore, the CPU 51 displays the images 72A and 72B of chips on the bet screen 70 in a distinct manner, based on the identified type of bet.

Next, in S103, the CPU 51 determines whether or not the betting period has expired. Specifically, it is determined whether or not a predefined time length (e.g. 20 sec) has passed since accepting the bet operation was started in S102.

If it is determined that the betting period has not expired (S103: NO), accepting the bet operation is continued. If, on the other hand, it is determined that the betting period has expired (S103: YES), the process flow proceeds to S104.

In S104, the CPU 51 transmits the bet information to the main control unit 31. Here, the bet information includes the information relating to the amount of bets (the number of credits) placed by the player, or the information relating to the type of bet (whether or not the bet operation has been performed using the bet-with-a-bonus button 201) placed by the player.

Additionally, in S105, the CPU 51 receives, from the main control unit 31, the deal card information (such as type of mark and or having a mark of “$” or not) of the first and the second card associated (dealt) to the player at each of the terminals 4. Then, in S106, the CPU 51 displays the cards associated with the bet screen 70, based on the deal card information of the cards received in S105.

Then, in S107, the CPU 51 starts acceptance of operation of the various operation buttons 78 to 81 displayed in the bet screen 70. In S108, particularly, the CPU 51 determines whether or not the HIT buttons 79 are touched. If it is determined that the HIT buttons 79 are touched (S108: YES), the CPU 51 demands to be dealt a new card from the main control unit 31 (S109). Next, in S110, the CPU 51 receives the deal card information transmitted from the main control unit 31. The CPU 51 displays the cards associated newly with the bet screen 70, based on the received deal card information (S111). If, on the other hand, it is determined that the HIT buttons 79 are not touched (S108: NO), the process flow proceeds to S112.

In S112, the CPU 51 determines whether or not the STAND buttons 78 are touched. If it is determined that the STAND buttons 78 are touched (S112: YES), the CPU 51 transmits the card decision information that the player determines to play the cards displayed currently with the dealer to the main control unit 31 (S113). If, on the other hand, it is determined that the STAND buttons 78 are not touched (S112: NO), the process flow returns to S108. Here, if the other operation buttons 80 to 84 is touched, the CPU 51 executes a process corresponding to the touched button.

Next, in S114, the CPU 51 receives the determination result of win or loss transmitted from the main control unit 31. Then, in S115, the CPU 51 displays, on the liquid crystal display 10, the determination result of win or loss of the player who is playing at the terminal 4, based on the determination result of win or loss received in S114. Specifically, a character string “DRAW” is displayed on the win-or-loss display area 95 of the bet screen 70 (see FIG. 8) when the result turned out to be a draw. If the player wins, a character string “YOU WON” is displayed. Furthermore, a character string “YOU LOST” is displayed if the player loses.

Subsequently, in S116, the CPU 51 determines whether or not a bet-with-a-bonus operation has been performed, based on the bet information transmitted in S104. Here, also in this determination, it is determined that a bet-with-a-bonus operation has been performed when a bet has been placed using the bet-with-a-bonus button 201. Then, if it is determined that no bet-with-a-bonus operation has been performed (S116: NO), the process flow proceeds to S117. In S117, an ordinary payout is made. Specifically, credits twice as many as the amount of bets are paid to the player if the player defeats the dealer. Then, the CPU 51 terminates the game processing program.

If, on the other hand, it is determined that a bet-with-a-bonus operation has been performed (S116: YES), the process flow proceeds to S118. In S118, a payout is made with the amount of the award changed from the case of S117. Specifically, credits 1.7 times as many as the amount of bets are paid to the player if the player defeats the dealer. Then, the process flow proceeds to S119 so as to execute the bonus game.

In S119, the CPU 51 determinates whether or not a card which is marked with a mark 401 of “$” is one of the cards which are associated to the player on the bet screen 70. The determination is based on the card deal information received in S105 or in S110. Here, if it is determined no card which is marked with a mark 401 of “$” is one of the cards which are associated to the player on the bet screen 70 (S119: NO), the CPU 51 terminates the game processing program. If, on the other hand, it is determined the card which is marked with a mark 401 of “$” is one of the cards which are associated to the player on the bet screen 70 (S119: YES), the process flow proceeds to S120.

Subsequently, in S120, the CPU 51 awards the amount of pool which is pooled in the pot currently to the player, as a prize. And the CPU 51 displays a character string “YOU GOT JACK POT IN BJ BONUS GAME!” on the bet screen 70. The CPU 51 awards the amount of pool stored in the amount of pool storing area 42A to the player. In addition, when the CPU 51 awards the prize to a plurality of the players at the same time, the CPU 51 awards the prize divided by the ratio (for example, in a case of two players, 50%) divided equally by the number of the players who realized a condition to each of the players. The CPU 51 initializes the amount of pool to an initial value (for example, “100”). With regard to this, the initial value may be “0”. Then, the CPU 51 terminates the game processing program.

Note that the present invention is not limited to the above examples, and various kinds of improvement or modification are possible without deviating from the scope of the present invention.

For example, in the present embodiment, the number of credits provided to the player who won in the bonus game may be varied within the range of the amount of pool that stored in the amount of pool storing area 42A. Therefore, it may be arranged such that, for example, the CPU 41 of the main control unit 31, acquires, by lottery, a value within the range of 0.01 to 0.1 and includes the value in the determination result of win or loss transmitted to each of the terminals 4 in S12. The lottery may be executed either by hardware or software. On the other hand, the CPU 51 of each of the terminals 4 executes payout of the amount of pool that multiplied the value included in the determination result of win or loss, in S120.

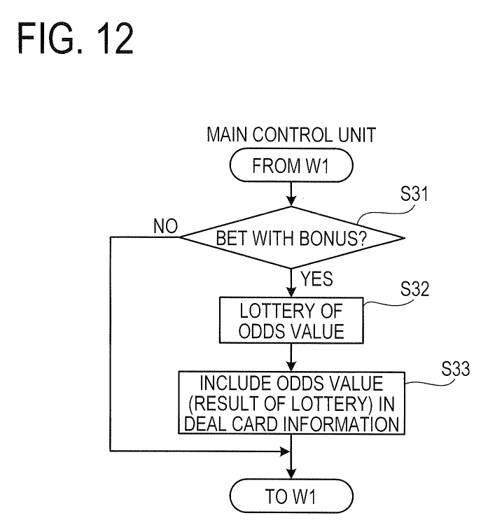

Additionally, in Blackjack with the present embodiment, when the player indicates the amount of bets using the bet-with-a-bonus button 201, the odds for which may be changed (it is fixed at x1.7 in the above example). Therefore, it may be arranged such that, for example, the main control unit 31 executes a game processing program shown in FIG. 12 at a time point W1 located in the middle between S4 and S5 of the game processing program shown in FIG. 10. In other words, when the bet information is received by S4 of the game processing program shown in FIG. 12, the process flow proceeds to S31 of the game processing program shown in FIG. 12 where the CPU 41 of the main control unit 31 determines whether or not a bet-with-a-bonus operation has been performed. This determination is based on the bet information received from each of the terminals 4, and it is determined that a bet-with-a bonus operation has been performed if a bet operation has been performed using the bet-with-a-bonus button 201. Here, for a terminal 4 which is determined that no bet-for-a-bonus operation has been performed thereon (S31: NO), the process flow returns to the game processing program shown in FIG. 10 and proceeds to S5 without doing anything. On the other hand, for a terminal 4 which is determined that a bet-with-a-bonus operation has been performed thereon (S31: YES), the process flow proceeds to S32.

In S32, the CPU 41 acquires, by lottery, an odds value within the range of x0.1 to x1.7. The lottery may be executed either by hardware or software. Subsequently, in S33, the CPU 41 includes the odds value acquired in S32 into the deal card information (see S5 of FIG. 10), then the process flow returns to the game processing program shown in FIG. 10 and proceeds to S5.

In this manner, when the main control unit 31 executes the game processing program shown in FIG. 12, the CPU 51 of each of the terminals 4 displays, in S105 of the game processing program shown in FIG. 10, the odds value included in the deal card information on the message area 85 of the bet screen 70. For example, if the odds value included in the deal card information is x0.5, a character string “BET WITH BONUS IS INDICATED! YOUR ODDS IS x0.5. YOU WILL HAVE A BONUS GAME!” is displayed on the message area 85 of the bet screen 70. Furthermore, when the process flow proceeds to S118 of the game processing program shown in FIG. 11, the CPU 51 of each of the terminals 4 executes payout of an award based on the odds value included in the deal card information.

In addition, the present embodiment may be limited such that the bonus game executed subsequent to Blackjack is executed only if the player side wins in Blackjack.

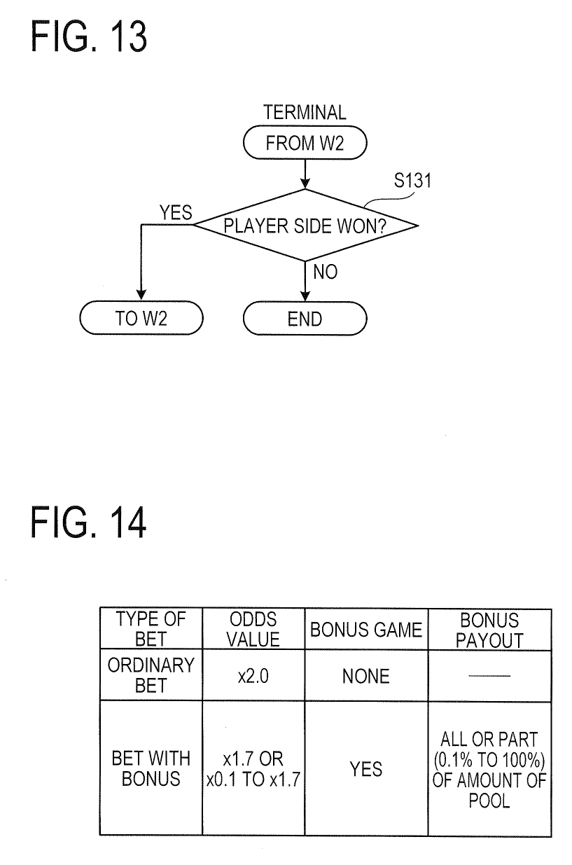

Therefore, it may be arranged such that, for example, the terminal 4 executes a game processing program shown in FIG. 13 at a time point W2 located in the middle between S118 and S119 of the game processing program shown in FIG. 11. In other words, when the reduced payout processing is executed in S118 of the game processing program shown in FIG. 11, the process flow proceeds to S131 of FIG. 13 where the CPU 51 of each of terminals 4 determines whether or not the player side has won in Blackjack at the terminal 4. The determination is based on the determination result of win or loss in S114 of the game processing program shown in FIG. 11. Here, if it is determined that the player side has won in Blackjack of the terminal 4 (S131: YES), the process flow proceeds to S119 of the game processing program shown in FIG. 11, and the CPU 51 executes the bonus game at the terminal 4. If, on the other hand, it is determined that the player side has not won (defeat or draw) in Blackjack at the terminal 4 (S131: NO), the main control unit 31 subsequently terminates the game processing program.

In this manner, if each of the terminals 4 executes the game processing program shown in FIG. 13, the bonus game executed subsequent to Blackjack is executed only on the terminal 4 at which the player side won in Blackjack.

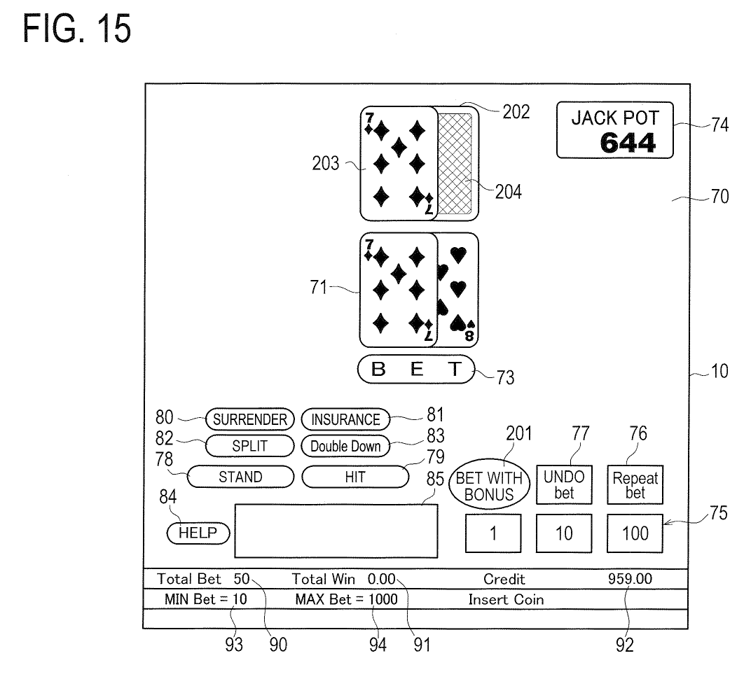

Additionally, with the present embodiment, the card gaming machine 1 which executes Blackjack and the bonus game may be a gaming machine on which the above-mentioned control unit 31 and the terminal 4 are integrated. In this case, the dealer cards which are the hand cards dealt to the dealer must also be displayed on the liquid crystal display 10 together with the player cards which are hand cards dealt to the player. FIG. 15 shows an exemplary the bet screen 70 on which the dealer cards and the player cards are simultaneously displayed. In this case, a dealer card display area 202, in which face-up images or face-down images of the dealer cards are displayed on the upper part of the player card display area 71, is reserved in the bet screen 70 described above. Here, in FIG. 15, both face-down images 203 of the dealer cards and face-down images 204 of the dealer cards, which are dealt to the dealer, are displayed in the dealer card display area 202.

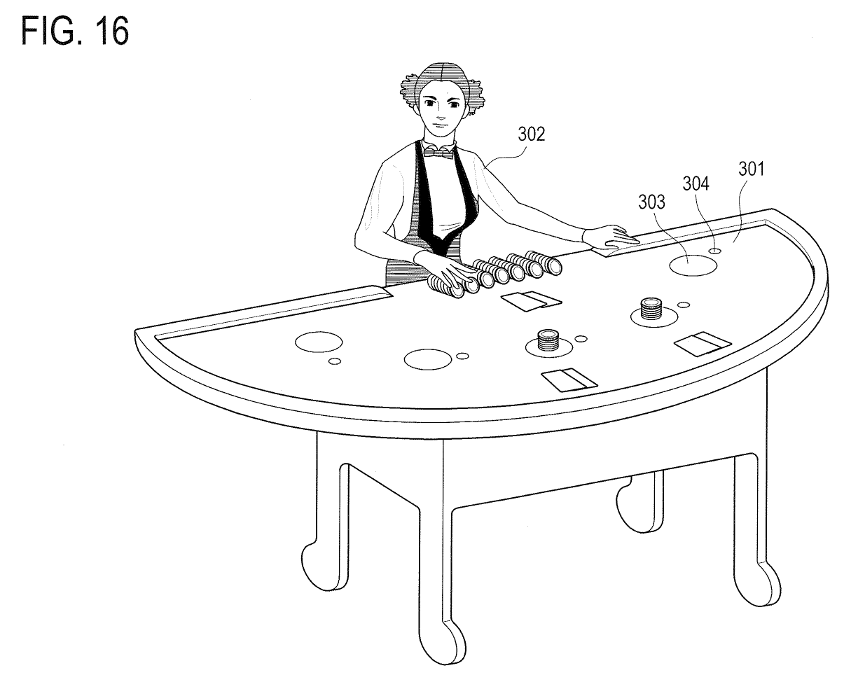

In addition, the playing method of the card game according to the present invention can also be applied to Blackjack (so-called table game) played by the dealer 302 and the player (not shown) on a gaming table 301, as shown in FIG. 16.

In the table game shown in FIG. 16, the dealer 302 deals cards to the dealer and each player on the gaming table 301. The player places a bet by putting chips on a bet spot 303 of the gaming table 301. In this occasion, if chips are further put on a particular spot 304 adjacent to the bet spot 303, the dealer 302 determines that a bet-with-a-bonus operation has been performed. However, the dealer 302 may also determine that a bet-with-a-bonus operation has been performed if special chips are put on the bet spot 303.

In addition, the dealer 302 plays Blackjack by using a card deck including a plurality of cards (for example, five cards) which are marked a mark 401 of “$” so as to execute a bonus game subsequent to Blackjack.

The dealer 302 pools the amount of the bets by collecting the chips of the player's bet to a predefined pot on the gaming table 301, if neither player nor dealer wins in Blackjack.

Furthermore, the dealer 302 can award the amount of pool to a player by delivering the chips collected to the predefined pot if the player realizes a predefined condition in the bonus game.

As described above, with the card gaming machine 1 and playing method of the card game according to the present embodiment, there are an ordinary bet operation using only the bet button 75 without using the bet-with-a-bonus button 201, and a bet-with-a-bonus operation using both the bet-with-a-bonus button 201 and the bet button 75, as the bet operation of Blackjack. In this regard, FIG. 14 is a table showing the difference between the ordinary bet operation and the bet-with-a-bonus operation.

If an ordinary bet operation is performed in Blackjack, the odds value is fixed to x2.0 and no bonus game will be executed subsequent to Blackjack, as shown in FIG. 14.

If, on the other hand, a bet-with-a-bonus operation is performed in Blackjack, the odds value is fixed to x1.7 or varied within the range of x0.1 to x1.7. Furthermore, the bonus game is executed subsequent to Blackjack, and a fixed number of the total amount of pool or varied within the range of the number of the amount of pool x0.1 to the number of the amount of pool x1.0 will be awarded as a bonus payout to the winner of the bonus game.

Here, an additional condition such that the player has to win in Blackjack may be posed in order to execute the bonus game subsequent to Blackjack.

What is claimed is:

1. A gaming machine comprising:
a display device for displaying cards which are dealt in a main game;
an input unit for allowing a player to enter instructions related to a progress of the main game;
an operation unit for allowing the player to indicate the number of bets of one of a first type and a second type for a win of the player's side in the main game;
a memory for storing the number of credits held by the player; and
a processor programmed to execute the main game by executing processes of:
when the number of bets of the first type is indicated by an operation on the operation unit,
(a) displaying on the screen, upon completion of the player's performing the operation of indicating the number of bets using the operation unit, in condition to be face-up of both cards of two cards which have been dealt as player cards, in condition to be face-up of a first card of two cards which have been dealt as dealer cards, and in condition to be face-down of a second card of two cards which have been dealt as the dealer cards;
(b) determining, based on the player's instructions using the input unit, whether or not a card is dealt in addition to the player cards which have been displayed on the display device;
(c) displaying cards of the number of being dealt additionally as the player cards, if it is determined to deal a card in addition to the player cards;
(d) determining, based on a predefined rule, whether or not a card is dealt in addition to the dealer cards which have been displayed on the display device;
(e) displaying cards of the number of being dealt additionally as the dealer cards, if it is determined to deal a card in addition to the dealer cards;
(f) determining whether or not the player side wins, based on both a combination of a plurality of the cards which have been displayed on the display device as the player cards and a combination of a plurality of the cards which have been displayed on the display device as the dealer cards; and
(g) if the player side wins, adding the number of credits calculated using a predefined odds to the number of credits in the memory and storing the sum,
when, otherwise, the number of bets of the second type is indicated by an operation on the operation unit,
(h) changing the odds to a lower value than the predefined odds and executing the main game;
(i) randomly determining whether or not to award a bonus to the player; and
(j) if it is determined to award the bonus to the player, adding the number of credits according to the bonus to the number of credits in the memory and storing the sum.

2. The gaming machine according to claim 1, wherein
the processor is programmed to randomly determine whether or not to award the bonus to the player by executing processes of:
(a) using a card deck including one card or more than one card, which is marked with a predefined mark; and
(b) if the player cards which consists of a plurality of the cards displayed on the display device, includes the card marked with the predefined mark, determining to award the bonus to the player.

3. The gaming machine according to claim 1, wherein
the processor is programmed to randomly determine whether or not to award the bonus to the player by executing processes of:
(a) separately from the main game, determining to award the bonus to the player.

4. A game playing method comprising, so as to make a main game proceed, the steps of: when a player indicates the number of bets of a first type for a win of the player's side in the main game,
(a) dealing, upon completion of the player's indicating the number of bets, two face-up cards as player cards, a face-up card as a first card out of two cards of dealer cards, and a face-down card as a second card out of two cards of the dealer cards;
(b) determining, based on the player's instructions, whether or not a card is dealt in addition to the player cards;
(c) dealing cards of the number of being dealt additionally as the player cards, if it is determined to deal a card in addition to the player cards;
(d) determining, based on a predefined rule, whether or not a card is dealt in addition to the dealer cards;
(e) dealing cards of the number of being dealt additionally as the dealer cards, if it is determined to deal a card in addition to the dealer cards;
(f) determining whether or not the player side wins, based on both a combination of a plurality of the cards as the player cards and a combination of a plurality of the cards as the dealer cards; and
(g) if the player side wins, the number of credits calculated using a predefined odds are awarded to the player,
when, otherwise, the player indicates the number of bets of a second type for a win of the player's side in the main game;
(h) changing the odds to a lower value than the predefined odds and executing the main game;
(i) randomly determining whether or not to award a bonus to the player; and
(j) if it is determined to award the bonus to the player, awarding the number of credits according to the bonus to the player.

5. The game playing method according to claim 4 comprising the steps of: so as to randomly determine whether or not to award the bonus to the player,
(a) using a card deck including one card or more than one card, which is marked with a predefined mark; and
(b) if the player cards which consists of a plurality of the cards, includes the card marked with the predefined mark, determining to award the bonus to the player.

6. The game playing method according to claim 4 comprising the steps of: so as to randomly determine whether or not to award the bonus to the player,
(a) separately from the main game, determining to award the bonus to the player.
